(19) United States
(12) Patent Application Publication
(10) Pub. No.: US 2014/0066747 A1
(43) Pub. Date: Mar. 6, 2014

(54) Episodic Memory Stimulation

(71) Applicant: Dennis E. Fortier, Laguna Niguel, CA (US)

(72) Inventor: Dennis E. Fortier, Laguna Niguel, CA (US)

(21) Appl. No.: 14/015,702

(22) Filed: Aug. 30, 2013

Related U.S. Application Data
(60) Provisional application No. 61/694,773, filed on Aug. 30, 2012.

(51) Int. Cl. G09B 5/00; A63F 9/24

(52) U.S. Cl. CPC G09B 5/00; A63F 9/24
USPC 600/410; 600/544; 600/425; 434/236

(57) ABSTRACT

The present invention comprises, without limitation, a method to maintain or increase brain health, wherein the method comprises a means to input information known to an individual, a means for an individual to access such information, access of the information by the individual, wherein the information evokes an episodic memory that stimulates brain health.

### INTRODUCTION

This U.S. Non-Provisional patent application claims priority pursuant to 35 U.S.C. §119(e) to U.S. Provisional patent application 61/694,773, filed on Aug. 30, 2012, the contents of which is hereby incorporated by reference in its entirety.

Episodic memory is a category of memory that involves the recollection of specific events, situations, experiences, associated emotions and contextual knowledge. Examples of episodic memory include daily events that are interesting of important to an individual for some reason. Examples also include, but are not limited to, milestone experiences like the first day of school, an individual's first kiss, attending a friend's birthday party or graduation, learning to drive, a new residence or new school, the death of a family member, a first paycheck, and other meaningful events. Episodic memories can also include the location and time that an event occurred, the weather on that day and other contextual knowledge that help to form the complete episodic memory.

Certain biological facts in the field of brain health have been well established. For example, healthy neurons that receive proper nourishment and oxygen are an important part of overall brain health and cognitive function. Performing cognitive tasks can stimulate blood flow to a particular brain region or network of neurons to nourish brain cells with oxygen and other vital nutrients. This is especially true for tasks involving episodic recall.

In recent years, there has been a considerable amount of research and commercial activity to identify and implement methods to increase brain health through the use of stimuli. One area of significant activity has been the field of computerized brain games. Examples of such games include LUMOSITY®, POSIT SCIENCE®, and BRAIN AGE® for the NINTENDO DS®. The most common approaches followed by these brain games are to provide a series of challenges based on item memorization, item recognition, processing speed, value judgment, vocabulary, pattern recognition, numeric calculations, and logic puzzles, with the intent that these mental exercises will function as a general brain work-out.

The general concept underlying the use of these games is the belief that they stimulate brain health through the induction of cognitive activity and that, compared to non-activity, this will have a positive impact on brain health. However, there is no convincing scientific evidence that such structured cognitive activities actually enhance cognition or overall brain health.

While playing brain games can be entertaining, a resulting positive effect on brain health is unproven and likely minimal at best. It is fairly common, for subjects who play brain games, to see a test effect or learning effect that results in improved performance on the tasks in the games they play, but a generalized benefit of enhanced cognitive abilities in everyday life has not been demonstrated in the scientific literature.

The present invention overcomes the liabilities associated with previous brain games and other similar activities by using a more individualized approach that stimulates episodic memory. This type of stimulation results in greater usage of specific neural circuits, those that must fire to recall a specific episodic memory, which results in a biological response to nourish the neurons in those circuits and improved overall brain health.

### SUMMARY

In an aspect, the present invention constitutes a method to maintain or increase brain health, wherein the method comprises a means to input information known to an individual, a means for an individual to access such information, access of the information by the individual, wherein the information evokes an episodic memory that stimulates brain health. In a further aspect, the information is, without limitation, stored in an electronic means and in a further aspect, the electronic means is, without limitation, a computer, a tablet, a cell phone or a gaming device. In an aspect, the information is, without limitation, inputted into an electronic database and further, without limitation, the electronic database is a social network or an electronic game.

In an aspect, the present invention constitutes a method to maintain or increase brain health, wherein the method comprises a means to input information known to an individual into an electronic database, a means for an individual to access such information stored in an electronic database, access of the information stored in an electronic database by the individual, wherein the information evokes an episodic memory that stimulates brain health. In a further aspect, the electronic database is, without limitation, a social network or electronic game. In another aspect, the information is inputted by an individual other than the individual who will access the information.

In an aspect, the present invention constitutes a method to maintain or increase brain health, wherein the method comprises a means to evoke episodic information known to an individual, access of the information by the individual, wherein the information evokes an episodic memory that stimulates brain health. In a further aspect, the method comprises a game set forth in a solid medium and further, without limitation, the game is a board game or a card game.

In an aspect, the present invention constitutes a method to maintain or increase brain health, wherein the method comprises a means to input information known to an individual, a means for an individual to access such information, access of the information by the individual, and a means to measure a response by the individual, wherein the information evokes an episodic memory that stimulates brain health.

In an aspect, the present invention constitutes a game set forth in a solid medium, wherein the game provides information that evokes episodic memories in an individual.

### DESCRIPTION

Maintenance of brain health, particularly in older individuals, is an important goal as brain health relates to brain function. Furthermore, and maintaining good brain health can delay the onset or reduce the severity of neurological diseases including Alzheimer's disease, Parkinson's, and other brain-based diseases. Maintaining brain health, even at a younger age, can lead to improved cognition and overall brain function. Among the benefits that result from improved brain health are a reduction in brain atrophy and a decrease in the loss of metabolic activity in the brain.

Research efforts suggest that one effective approach to maintaining brain health may be to stimulate cognitive activity in the brain. Such stimulation can result in a biological response to deliver proteins, lipids, oxygen and other nutrients to those neurons in the stimulated neural circuits. Computerized brain exercises, aimed at promoting good neural cell health, require individuals to complete a regular regimen of cognitive exercise. Though such brain games and other similar stimuli have been available for use by individuals for several years, there is no scientific evidence to show that they actually promote overall brain health.

A better means to stimulating brain health and maintaining or increasing cognitive ability, is to provide stimuli that activate neural networks used in the formation of episodic memories. An ideal set of such stimuli would evoke various episodic memories, based on an individual's particular set of experiences.

Episodic memory is a form of memory based on personal experience and involves the recollection of specific events, situations, experiences, associated emotions, times, places, contextual knowledge and other conception-based knowledge in relation to that experience. Examples of episodic memory include daily events that are interesting of important to an individual for some reason. Examples also include, but are not limited to, milestone experiences like the first day of school, an individual's first kiss, attending a friend's birthday party or graduation, learning to drive, a new residence or new school, the death of a family member, a first paycheck, and other meaningful events. In addition to an individual's overall recall of the event itself, episodic memory may also include an individual memory of the location and time that an event occurred.

Episodic memory represents our memory of experiences and specific events in time in a serial form, from which we can reconstruct the actual events that took place at any given point in our lives. It is the memory of autobiographical events (times, places, associated emotions and other contextual knowledge) that can be explicitly stated. Individuals tend to see themselves as actors in these events, and the emotional charge and the entire context surrounding an event is usually part of the memory, not just the bare facts of the event itself.

Stimulation of an individual's brain, by evoking episodic memories, provides a specific process to exercise neural circuits that may otherwise lay dormant and slowly degrade, if not for the occasional, randomly-triggered, retrieval of the episodic memory. In addition, since each episodic memory is reconstructed by firing its own sequence of individual neural circuits, retrieving different episodic memories exercises different neural circuits, which contributes to a widespread delivery of nutrients to many neurons.

The evocation of episodic memories is different than challenging the brain to perform a creative task, solve a problem, recognize a pattern, or recall general information, which are the bases for previous efforts in the brain exercise field. Each of these is limited, as they essentially require the brain to perform the same function over and over, resulting in the stimulation of a specific area of the brain again and again. This traditional approach does not require stimulation of the many neural networks through which episodic memories are stored and recalled, and therefore, do not benefit those particular neural networks.

One approach to stimulating someone's brain to retrieve a particular episodic memory is to generate and present a “trigger” such as a single aspect of a rich, multi-faceted, episodic memory, in order to stimulate recall of the full episode, complete with context, emotion, and further details. One means of providing such triggers is through the use of written information, images, sounds, or other sensory stimuli. Another approach is through the presentation of questions that solicit retrieval of episodic memories related to the answer to the question.

There are various means for storing and/or accessing information that can be used for triggering the evocation of an episodic memory. For instance, an individual could use an electronic application that allows input and/or access to personal information that individuals make available about themselves. This could be a program on a computer (including a desktop, a laptop or other computer like device), a cell phone (including a smartphone), an MP3 player such as an iTouch, an iPad or other tablet computer, or any other device capable of storing information and providing access to a user.

It could also be a game on a game playing device, including, but not limited to the Nintendo Wii, Xbox, Playstation, Gameboy (including DS, 3D and any other Gameboy or Gameboy like device), PsP, PsVita, or any other device capable of playing a game that allows the user to input information and access such information.

The information can also be stored in an online site that allows data input and/or access, including social network sites, such as Facebook, Twitter, LinkedIn, FourSquare, StumbleUpon, Pinterest, Flicker, Instagram, Myspace, and other sites where information about an individual can be stored and/or accessed.

Another means to evoking episodic memories is through social mechanisms that allow individual A to trigger episodic memories within the brains of individuals B, C, and D, to whom individual A is connected via electronic means, such as a social network, a central database, or other electronic storage means, as well as non-electronic means, such as postal mail or other non-electronic forms of communication. Incorporating information provided by networked individuals, and using that information as the basis for evoking episodic memories among members of the network could greatly expand the sources of available stimuli to an infinite and ever-expanding pool of episodic memories.

The information necessary to evoke an episodic memory could also be accessed through the use of a predetermined set of questions. For instance, a board game that includes a means for asking relevant questions can be used to evoke episodic memories. Additionally, a card game or some other game using a solid interface in which questions or other information can be recorded can be used to evoke an episodic memory. The information solicited in such board game or card game or other game using a solid interface can be used as a means of retrieving the episodic memory wherein the questions can be random through a mixing and matching of different components of such board game or card game or other game using a solid interface.

Information to evoke an episodic memory can be inputted by an individual for whom the memory occurred. The information can also be inputted by an additional individual other than the individual for whom the memory occurred. Such individual can be a family member, including spouse, sibling, child, parent, cousin or other relative. Such individual can also be a friend, an acquaintance, a co-worker, or other individual who has knowledge of an event in the individual for whom the episodic memory has relevance.

The type of information that can be inputted for use to evoke an episodic memory can include, but is not limited to, information such as chronology of life milestones (birth, graduation. marriage, etc.), schools attended, locations visited or lived in, events attended, preferences for books, movies, and music, pictures, personal photos, including those posted by the individual or other individuals with access to the individual's electronic storage means, including a social network, major relevant news stories that were physically or temporally proximate to an individual's life or other information known to an individual that is capable of triggering an episodic memory. Using this information, the means for stimulating an episodic memory could be drawn from a database of items likely to evoke an episodic memory within an individual's brain. The invention will deliver a stream of stimulants to users in order to evoke episodic memories and exercise the users' brains.

Additional means can also be used to fine-tune the information (which includes other triggers) to evoke an episodic memory so that the information evokes a true episodic memory that stimulates the brain. For instance, an individual can rate whether or not a trigger actually evoked a true episodic memory by giving each trigger a rating that indicates the strength of the episodic memory evoked. One means by which the information can be fine-tuned is to use an algorithm, or other formula or means, capable of evaluating the effectiveness of the information for evoking a memory.

Another means by which an episodic memory can be evoked is by providing a means that allows an individual to request a trigger be provided at random, or at a particular time, for instance a particular time of day, day of the week, week of the month, or month of the year, or at any time on demand. Such trigger can be provided on a device, such as a cell phone, including, but not limited to a smart phone, a computer or computer like device, a game device or other device or means by which a trigger can be provided to an individual. Using such a device, the individual could select a trigger rate that meets their requirements from a menu of options, or they could abide by a default rate set by the device through which such triggers are provided. By providing a means to control when a trigger is provided, individuals will have control over how much and how frequently they receive stimuli for maintaining or increasing their brain health.

An episodic memory can also be evoked by a means that requires an individual to demonstrate recall of an episodic memory by correctly identifying an additional piece of information associated with the memory. With this approach, rather than delivering a trigger to an individual, the invention could deliver a question about an episodic memory the user is likely to have stored. With this approach, the invention would merely pose a question and challenge an individual to recall a memory without the aid of a trigger. As a result, an individual would be able to recall a personal episodic memory without a trigger resulting in the stimulation of the brain and maintenance or increase in brain health.

In an embodiment, the means for an individual to access such information is through receipt by the individual of an email, a telephone call, a text, or other communication means.

To measure the effectiveness of episodic memory evocation, means can be used to measure the ongoing cognitive performance of an individual or individuals who use the invention by scoring and monitoring their ability to correctly identify additional information associated with the episodic memories the invention triggers for them. Additionally, changes in cognitive performance can be measured through the use of general measures of cognition.

By stimulating brain health through the use of information to evoke episodic memories according to the invention, brain health of an individual can be increased 5%, 10%, 15%, 20%, 25%, 30%, 35%, 40%, 45%, 50%, 55%, 60%, 65%, 70%, 75%, 80%, 85%, 90%, 95% or 100% when compared to an individual who was not provided information to evoke episodic memories.

Means to measure brain health include positron emission tomography (PET), magnetic resonance imaging (MRI), and neuropsychological testing. For instance, a PET scan could be used to measure metabolic activity in the brain. This can include, but is not limited to, using PET as a means of demonstrating that metabolic activity has been consistently maintained or increased throughout the brain in subjects exposed to episodic memory stimulation. MRI could be used to show that an individual's brain has not atrophied with age as would be expected to occur without episodic memory evocation stimulation of the brain. Neuropsychological testing could be used to demonstrate increased levels of cognitive function in subjects using episodic memory stimulation compared to a control group that is not using episodic memory stimulation.

An example of a PET is fluorodeoxyglucose positron emission tomography (FDG-PET). Each of PET and MRI are sensitive to the effects of training such as that disclosed herein to evoke an episodic memory. An example of an MRI that can be used is the Siemens 3T MAGNETOM Trio System (Erlangen, Germany). Memory evocation can also be measured using any other means known to one of skill that is capable of measuring brain health.

### EXAMPLES

The following non-limiting examples are provided for illustrative purposes only in order to facilitate a more complete understanding of the disclosed subject matter. These examples should not be construed to limit any of the embodiments described in the present specification, including those pertaining to the methods, electronic databases and games disclosed herein.

### Example 1

An individual inputs information related to their daily personal life, including schools attended, date of birth, places lived, sports they follow, movies and television shows they view, employment timeline, news items they read or “like”, education background, and other autobiographical information, into an internet based social network. Following the input of information, the individual opts to receive stimuli generated from the information they have provided, aimed at evoking their episodic memories, in accordance with a schedule they select, via devices they select. From that point forward, the invention mines the information that the individual provides about their life, generates stimuli likely to evoke episodic memories (news items, anecdotes, photos of friends and/or travel destinations, audio files of music and/or movie lines, etc.) and send the stimuli to the user through those means the user designated (SMS, email, phone, internet inbox, etc.). By evoking episodic memories, the individual is able to exercise previously formed but perhaps dormant neural networks used to store those memories, and maintain or increase their brain health.

### Example 2

An individual inputs information about themselves and their life experiences, including places lived, schools attended, places traveled, date and place of birth, likes and dislikes, and other daily episodic events into a social network that takes such information and provides questions to evoke episodic memories. For instance, the individual attended a particular University. The invention will then generate and present questions to the individual, based on information accessed through the social network. For example, a question might relate to how that University's football program performed during the individual's years of attendance. The responses to the questions not only evoke episodic memories related to the football program, but episodic memories related to other events experience by the individual during their attendance at the University. These various episodic memories stimulate different sets of neurons in the individual's brain, increasing brain health.

### Example 3

An individual plays a board game that includes questions that are capable of evoking episodic memories. The questions asked may include those related to an individual's favorite writer or vacation spot, place of birth, favorite television show and movie. To respond, the individual must evoke episodic memories that stimulate the brain and increase brain health.

### Example 4

An individual who is suffering the onset of Alzheimer's Disease is provided a program into which the individual and other individuals with information related to episodic events of the individual can input information related to such episodic events. The program is set up so that the individual who is suffering from the onset of Alzheimer's Disease is alerted twice a day by the program that the individual is to answer questions and be provided other information to stimulate episodic memories. The program may also provide pictures, music and other sounds that are related to the inputted information that are able to raise episodic memories that are evoked by such pictures, music or other sounds. Through the regular use of the program, and the evoking of episodic memories, the onset of Alzheimer's Disease is slowed down and the severity of Alzheimer's Disease is reduced as brain health is increased. Through the continued use of the program, the degradation of the individual's brain health is slowed down.

### Example 5

An individual plays an electronic game that asks questions that require an individual to provide a response selected from those generated by the game. As the individual answers one question, the next question uses the response from the prior questions to build on the information solicited. The next response by the game can also be a sound or picture that is related to a prior answer with the response to the sound or picture being used to provide additional stimuli. Through this process, the information solicited and responses to such information, pictures or sounds acts as a trigger and evokes an episodic memory related to the questions, pictures or sounds provided by the game. Once an episodic memory is triggered, the individual informs the game and the game begins a new line of questions to evoke a different episodic memory. The individual continues to play the electronic game until the individual determines that a sufficient number of episodic memories have been evoked. At this point, the individual ends the game. The game has a memory and remembers the answers to previously asked questions or responses to sound or picture stimuli, so that the type of information requested is not repeated and new triggers can be created. Through the evocation of episodic memories, the electronic game stimulates brain health.

### Example 6

A social network requests the input of information about individual A and all individuals who are associated with individual A through the social network. The social network also uses information inputted by additional individuals who belong to the same social network, that may or may not be known to individual A, where the information inputted by the other individuals has some relation to that inputted by individual A. The individual accesses the information available on the social network site to evoke episodic memories. As the individual accesses the information, the individual assigns a rating to the provided information to identify the strength of the information in evoking episodic memories. The social network accesses the rating information provided by the individual, and using an algorithm that identifies which information most effectively evoked episodic memories, then segregates the information that only moderately or weakly evoked episodic memories, such that the individual has a more difficult time accessing such information compared to the individual's ability to access information that strongly evoked episodic memories.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only, and is not intended to limit the scope of the present invention, which is defined solely by the claims. Accordingly, the present invention is not limited to that precisely as shown and described.

Certain embodiments of the present invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar referents used in the context of describing the present invention (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the present invention so claimed are inherently or expressly described and enabled herein.

All patent, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

1. A method to maintain or increase brain health, wherein the method comprises a means to input information known to an individual, a means for an individual to access such information, access of the information by the individual, wherein the information evokes an episodic memory that stimulates brain health.

2. The method of claim 1, wherein the information is stored in an electronic means.

3. The method of claim 2, wherein the electronic means is a computer, a tablet, a cell phone or a gaming device.

4. The method of claim 1, wherein the information is inputted into an electronic database.

5. The method of claim 4, wherein the electronic database is a social network or an electronic game.

6. A method to maintain or increase brain health, wherein the method comprises a means to input information known to an individual into an electronic database, a means for an individual to access such information stored in an electronic database, access of the information stored in an electronic database by the individual, wherein the information evokes an episodic memory that stimulates brain health.

7. The method of claim 6, wherein the electronic database is a social network or electronic game.

8. The method of claim 6, wherein the information is inputted by an individual other than the individual who will access the information.

9-11. (canceled)

12. A method to maintain or increase brain health, wherein the method comprises a means to input information known to an individual, a means for an individual to access such information, access of the information by the individual, and a means to measure a response by the individual, wherein the information evokes an episodic memory that stimulates brain health.

13. The method of claim 12, wherein the means to measure a response by an individual is through positron emission tomography or magnetic resonance imaging.

14-21. (canceled)

22. The method of claim 1, wherein the means for an individual to access such information is through receipt by the individual of an email, a telephone call, a text, or other communication means.

23. The method of claim 6, wherein the information is stored in an electronic means.

24. The method of claim 23, wherein the electronic means is a computer, a tablet, a cell phone or a gaming device.

25. The method of claim 6, wherein the electronic database is a social network or an electronic game.

26. The method of claim 12, wherein the information is stored in an electronic means.

27. The method of claim 26, wherein the electronic means is a computer, a tablet, a cell phone or a gaming device.

28. The method of claim 12 wherein the information is inputted into an electronic database.

29. The method of claim 28, wherein the electronic database is a social network or an electronic game.
